(19) United States
(12) Patent Application Publication
(10) Pub. No.: US 2010/0215519 A1
(43) Pub. Date: Aug. 26, 2010

(54) AIR OPERATED DOUBLE DIAPHRAGM OVER CENTER VALVE PUMP

(75) Inventors: Larry Francis Krebs, Vancouver, WA (US); Craig Daniel Sunada, Black Diamond, WA (US); Mark Edward Connell, Sandy, OR (US)

Correspondence Address: BROUSE MCDOWELL LPA, 388 SOUTH MAIN STREET, SUITE 500, AKRON, OH, 44311, US

(73) Assignee: IDEX AODD, INC., Mansfield, OH (US)

(21) Appl. No.: 12/392,581

(22) Filed: Feb. 25, 2009

(51) Int. Cl. F04B 45/033; F04B 45/02; F16K 31/44

(52) U.S. Cl. 417/393; 417/473; 251/213

(57) ABSTRACT

An air operated double diaphragm pump comprising an air valve mechanism. The air valve mechanism may comprise a single valve system that replaces the two valve system found in conventional air operated double diaphragm pumps. The position of the valve may be determined by the diaphragm motion of the pump up to a stall position. A spring-loaded mechanical actuation may complete the valve action from the stall position to the final or end of stroke position of the pump.

### I. BACKGROUND

A. Field of Invention

This invention pertains to the art of methods and apparatuses regarding air operated double diaphragm pumps.

B. Description of the Related Art

Conventional air operated double diaphragm (AODD) pumps utilize a two valve system to enable alternating air action between the pumps double diaphragms. Typically, the two valve system includes a pilot valve and a main spool valve. The motion of the pump's diaphragm assemblies causes the main spool valve to alternate between two positions in order to cause compressed air to be alternately drawn into and exhausted from the two fluid chambers of the pump as the two diaphragm assemblies reciprocate between a first and a second position. The movement of the main spool valve cannot rely solely on the motion of the diaphragms since the diaphragm motion would only push the valve to a center or stall position where both chambers are blocked off and unable to either draw in or exhaust out compressed air thereby causing a stall situation. Therefore, the pilot valve is included that directs a stream of compressed air to either end of the main spool valve in order to control the location of the main spool valve and to urge the main spool valve past the stall position. The pilot valve is controlled via actuator pins (push rods) that are contacted by the pump's diaphragm assemblies to control the movement of the pilot valve. Thus the pilot valve is controlled by the diaphragm movement of the pump and alternately directs compressed air to one end of the main spool valve thus controlling the location of the main spool valve.

Although known methods work well for their intended purpose, several disadvantages exist. Conventional valve systems/arrangements utilize a high number of parts, some of which require tight tolerances, thereby increasing the cost and complexity of the pump. Additionally, conventional valve systems typically require that the pump be taken off-line and disassembled in order to replace or repair one or more of the valves or components thereof.

What is needed then is a valve system for use with an air operated double diaphragm pump that reduces the cost and complexity of the pump; does not result in a significant reduction in the life expectancy of the pump's main wear components; and, maintains the same level of performance as valve conventional air operated double diaphragm pump valve systems.

### II. SUMMARY

According to one embodiment of the invention, a pump has a first diaphragm chamber, a second diaphragm chamber, a connecting rod, and an air valve mechanism. The first diaphragm chamber includes a first diaphragm assembly, wherein the first diaphragm assembly defines a first pumping chamber and a first fluid chamber within the first diaphragm chamber. The second diaphragm chamber includes a second diaphragm assembly, wherein the second diaphragm assembly defines a second pumping chamber and a second fluid chamber within the second diaphragm chamber. The connecting rod is connected between the first diaphragm assembly and the second diaphragm assembly to at least partially cause the first diaphragm assembly and the second diaphragm assembly to reciprocate between a first pump position and a second pump position. The air valve mechanism has a valve plate, a valve block, and a swing arm assembly. The valve plate has at least a first aperture suitable for allowing the passage of compressed air through the valve plate. The valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position. The swing arm assembly urges the valve block away from a stall position and towards the first block position or the second block position.

According to another embodiment of the invention, the pump also includes a housing, wherein the air valve mechanism is positioned substantially within the housing and the housing allows at least a portion of the air valve mechanism to be selectively removed from the pump. Optionally, the valve plate can remain fixedly connected to the pump when the housing is selectively removed from the pump.

According to another embodiment of the invention, the swing arm assembly further includes: an upper spring pin; a lower spring pin; a first swing arm; a second swing arm; and, at least a first spring that extends between the upper spring pin and the lower spring pin and has substantially a minimum amount of deflection at the first and second block positions and a maximum amount of deflection at the stall position. The lower spring pin is coupled to and extends between the first and second swing arms. The lower spring pin is urged away from the stall position by the first spring. The lower spring pin at least partially causes the completion of the movement of the valve block to the first or second block position. The lower spring pin may at least partially cause the completion of the movement of the valve block to the first or second block position by contacting a block face of the valve block. The block face at least partially define a swing arm recess formed in the valve block. At least a portion of the lower spring pin, the first swing arm, or the second swing arm is positioned within the swing arm recess.

According to another embodiment of the invention, the first swing arm rotates about a first swing arm support pin and the second swing arm rotates about a second swing arm support pin, the first and second swing arm support pins are positioned substantially outside the width of the valve block and along a vertical centerline, the lower spring pin extends across the width of the valve block and is positioned substantially between but radially apart from the first and second swing arm support pins.

According to one embodiment of the invention, an air valve mechanism includes a housing; a valve block; a valve plate; and, a swing arm assembly. The housing allows at least a portion of the air valve mechanism to be removably connected to an associated pump. The valve block, the valve plate, and the swing arm assembly are positioned substantially within the housing. The valve plate comprises a first aperture, a second aperture, and a third aperture suitable for allowing the passage of a compressed fluid through the valve plate. The valve block is positioned to move between a first block position that causes the first aperture to be in fluid communication with the second aperture and a second block position that causes the second aperture to be in fluid communication with the third aperture. The movement of the valve block between the first block position and the second block position is at least partially caused by the movement of a first diaphragm assembly and a second diaphragm assembly of the associated pump. The swing arm assembly provides a mechanical actuation that at least partially causes the valve block to move from a third block position that coincides with a stall position of the associated pump to the first or second block position.

According to another embodiment of the invention, the swing arm assembly includes an upper spring pin, a lower spring pin, a first swing arm support pin, a second swing arm support pin, a first swing arm and a second swing arm. The upper spring pin extends over the width of the valve block along a vertical centerline. The lower spring pin extends over the width of the valve block along the vertical centerline and is spaced radially apart from the upper spring pin. The first swing arm support pin and the second swing arm support pin are positioned substantially outside the width of the valve block along the vertical centerline between the upper and lower support pins. The first first swing arm rotates about the first swing arm support pin and the second swing arm rotates about the second swing arm support pin and the lower spring pin extends between and is coupled to the first and second swing arms.

According to another embodiment of the invention, the valve block further includes a swing arm recess. The swing arm recess is at least partially defined by a first block face and a second block face and a lower spring pin that extends across the width of the valve block at least partially within the swing arm recess and contacts the first block face or the second block face to move the valve block from the third block position.

According to one embodiment of the invention, a method has the steps of:

(a) providing a pump having: a first diaphragm chamber comprising a first diaphragm assembly, wherein the first diaphragm assembly defines a first pumping chamber and a first fluid chamber within the first diaphragm chamber; a second diaphragm chamber comprising a second diaphragm assembly, wherein the second diaphragm assembly defines a second pumping chamber and a second fluid chamber within the second diaphragm chamber; a connecting rod connected between the first diaphragm assembly and the second diaphragm assembly to at least partially cause the first diaphragm assembly and the second diaphragm assembly to reciprocate between a first pump position and a second pump position; and, an air valve mechanism having: a valve plate having at least a first aperture suitable for allowing the passage of compressed air through the valve plate; a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position; a swing arm assembly, wherein the swing arm assembly urges the valve block away from a stall position and towards the first block position or the second block position; and, a housing, wherein at least a portion of the air valve mechanism is positioned within the housing and the housing is removably connected to the pump;

(b) operating the pump for a first period of time;

(c) removing the housing and the at least a portion of the air valve mechanism that is positioned within the housing to provide in-line service to the air valve mechanism;

(d) connecting the housing to the pump; and,

(e) operating the pump for a second period of time.

According to another embodiment of the invention, a method has the steps of:

(a) providing a pump having: a first diaphragm chamber comprising a first diaphragm assembly, wherein the first diaphragm assembly defines a first pumping chamber and a first fluid chamber within the first diaphragm chamber; a second diaphragm chamber comprising a second diaphragm assembly, wherein the second diaphragm assembly defines a second pumping chamber and a second fluid chamber within the second diaphragm chamber; a connecting rod connected between the first diaphragm assembly and the second diaphragm assembly to at least partially cause the first diaphragm assembly and the second diaphragm assembly to reciprocate between a first pump position and a second pump position; and, an air valve mechanism having: a valve plate having at least a first aperture suitable for allowing the passage of compressed air through the valve plate; a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position; a swing arm assembly, wherein the swing arm assembly urges the valve block away from a stall position and towards the first block position or the second block position; and, a housing, wherein at least a portion of the air valve mechanism is positioned within the housing and the housing is removably connected to the pump;

attaching the housing to the exterior portion of a pump housing;

(b) operating the pump for a first period of time;

(c) removing the housing and the at least a portion of the air valve mechanism that is positioned within the housing to provide in-line service to the air valve mechanism;

(d) connecting the housing to the pump; and,

(e) operating the pump for a second period of time.

According to another embodiment of the invention, a method has the steps of:

(a) providing a pump having: a first diaphragm chamber comprising a first diaphragm assembly, wherein the first diaphragm assembly defines a first pumping chamber and a first fluid chamber within the first diaphragm chamber; a second diaphragm chamber comprising a second diaphragm assembly, wherein the second diaphragm assembly defines a second pumping chamber and a second fluid chamber within the second diaphragm chamber; a connecting rod connected between the first diaphragm assembly and the second diaphragm assembly to at least partially cause the first diaphragm assembly and the second diaphragm assembly to reciprocate between a first pump position and a second pump position; and, an air valve mechanism having: a valve plate having at least a first aperture suitable for allowing the passage of compressed air through the valve plate; a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position; a swing arm assembly, wherein the swing arm assembly urges the valve block away from a stall position and towards the first block position or the second block position; and, a housing, wherein at least a portion of the air valve mechanism is positioned within the housing and the housing is removably connected to the pump;

(b) operating the pump for a first period of time;

(c) removing the housing and the at least a portion of the air valve mechanism that is positioned within the housing to provide in-line service to the air valve mechanism;

leaving the valve plate coupled to the pump;

(d) connecting the housing to the pump; and,

(e) operating the pump for a second period of time.

According to another embodiment of the invention, a method has the steps of:

(a) providing a pump having: a first diaphragm chamber comprising a first diaphragm assembly, wherein the first diaphragm assembly defines a first pumping chamber and a first fluid chamber within the first diaphragm chamber; a second diaphragm chamber comprising a second diaphragm assembly, wherein the second diaphragm assembly defines a second pumping chamber and a second fluid chamber within the second diaphragm chamber; a connecting rod connected between the first diaphragm assembly and the second diaphragm assembly to at least partially cause the first diaphragm assembly and the second diaphragm assembly to reciprocate between a first pump position and a second pump position; and, an air valve mechanism having: a valve plate having at least a first aperture suitable for allowing the passage of compressed air through the valve plate; a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position; a swing arm assembly, wherein the swing arm assembly urges the valve block away from a stall position and towards the first block position or the second block position; and, a housing, wherein at least a portion of the air valve mechanism is positioned within the housing and the housing is removably connected to the pump;

(b) operating the pump for a first period of time;

(c) removing the housing and the at least a portion of the air valve mechanism that is positioned within the housing to provide in-line service to the air valve mechanism;

withdrawing a first and a second push rod from a first and a second housing aperture respectively, wherein the first and second push rods are operatively connected to the first and second diaphragm assemblies and contact at least a portion of the swing arm assembly to at least partially cause the valve block to move between the first and second block positions;

(d) connecting the housing to the pump;

inserting the first and second push rods into the first and second housing apertures respectively; and,

(e) operating the pump for a second period of time.

According to another embodiment of the invention, a method has the steps of:

(a) providing a pump having: a first diaphragm chamber comprising a first diaphragm assembly, wherein the first diaphragm assembly defines a first pumping chamber and a first fluid chamber within the first diaphragm chamber; a second diaphragm chamber comprising a second diaphragm assembly, wherein the second diaphragm assembly defines a second pumping chamber and a second fluid chamber within the second diaphragm chamber; a connecting rod connected between the first diaphragm assembly and the second diaphragm assembly to at least partially cause the first diaphragm assembly and the second diaphragm assembly to reciprocate between a first pump position and a second pump position; and, an air valve mechanism having: a valve plate having at least a first aperture suitable for allowing the passage of compressed air through the valve plate; a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position; a swing arm assembly, wherein the swing arm assembly urges the valve block away from a stall position and towards the first block position or the second block position; and, a housing, wherein at least a portion of the air valve mechanism is positioned within the housing and the housing is removably connected to the pump;

(b) operating the pump for a first period of time;

contacting at least a portion of the swing arm assembly with a first push rod to at least partially cause the valve block to move from the first block position;

deforming at least a first spring as the valve block moves from the first block position to the stall position;

relaxing the at least a first spring as the valve block moves from the stall position to the second block position, wherein the relaxing of the at least a first spring urges the valve block away from the stall position and towards the second block position;

(c) removing the housing and the at least a portion of the air valve mechanism that is positioned within the housing to provide in-line service to the air valve mechanism;

(d) connecting the housing to the pump; and,

(e) operating the pump for a second period of time.

According to another embodiment of the invention, a method has the steps of:

(a) providing a pump having: a first diaphragm chamber comprising a first diaphragm assembly, wherein the first diaphragm assembly defines a first pumping chamber and a first fluid chamber within the first diaphragm chamber; a second diaphragm chamber comprising a second diaphragm assembly, wherein the second diaphragm assembly defines a second pumping chamber and a second fluid chamber within the second diaphragm chamber; a connecting rod connected between the first diaphragm assembly and the second diaphragm assembly to at least partially cause the first diaphragm assembly and the second diaphragm assembly to reciprocate between a first pump position and a second pump position; and, an air valve mechanism having: a valve plate having at least a first aperture suitable for allowing the passage of compressed air through the valve plate; a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position; a swing arm assembly, wherein the swing arm assembly urges the valve block away from a stall position and towards the first block position or the second block position; and, a housing, wherein at least a portion of the air valve mechanism is positioned within the housing and the housing is removably connected to the pump;

(b) operating the pump for a first period of time;

contacting at least a portion of the swing arm assembly with a first push rod to at least partially cause the valve block to move from the first block position;

deforming at least a first spring as the valve block moves from the first block position to the stall position;

relaxing the at least a first spring as the valve block moves from the stall position to the second block position, wherein the relaxing of the at least a first spring urges the valve block away from the stall position and towards the second block position;

contacting at least a portion of the swing arm assembly with a second push rod to at least partially cause the valve block to move from the second block position;

deforming the at least a first spring as the valve block moves from the second block position to the stall position;

relaxing the at least a first spring as the valve block moves from the stall position to the first block position, wherein the relaxing of the at least a first spring urges the valve block away from the stall position and towards the first block position;

(c) removing the housing and the at least a portion of the air valve mechanism that is positioned within the housing to provide in-line service to the air valve mechanism;

(d) connecting the housing to the pump; and,

(e) operating the pump for a second period of time.

One advantage of this invention is the cost reduced design allows for a competitive advantage within the marketplace without sacrificing performance or longevity.

Another advantage is that the invention allows for the in-line serviceability of the valve system thereby reducing the time and cost associated with the repair or replacement of the valve system.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows a cross sectional view of an air operated double diaphragm pump comprising an air valve mechanism, wherein the pump comprises a first diaphragm position, according to one embodiment of the invention;

FIG. 2 shows a cross sectional view of an air operated double diaphragm pump comprising an air valve mechanism, wherein the pump comprises a second diaphragm position, according to one embodiment of the invention;

FIG. 3 shows a cross sectional view of an air operated double diaphragm pump comprising an air valve mechanism, wherein the pump comprises a third diaphragm position or a stall position, according to one embodiment of the invention;

FIG. 4 shows a cross sectional view of an air valve mechanism, wherein a valve block comprises a first block position, according to one embodiment of the invention;

FIG. 5 shows a cross sectional view of an air valve mechanism, wherein a valve block comprises a third block position, according to one embodiment of the invention;

FIG. 6 shows a top view of an air valve mechanism according to one embodiment of the invention;

FIG. 7 shows a cross sectional partial view of an air valve mechanism comprising a housing that allows for the in-line serviceability of the air valve mechanism according to one embodiment of the invention.

### IV. DETAILED DESCRIPTION

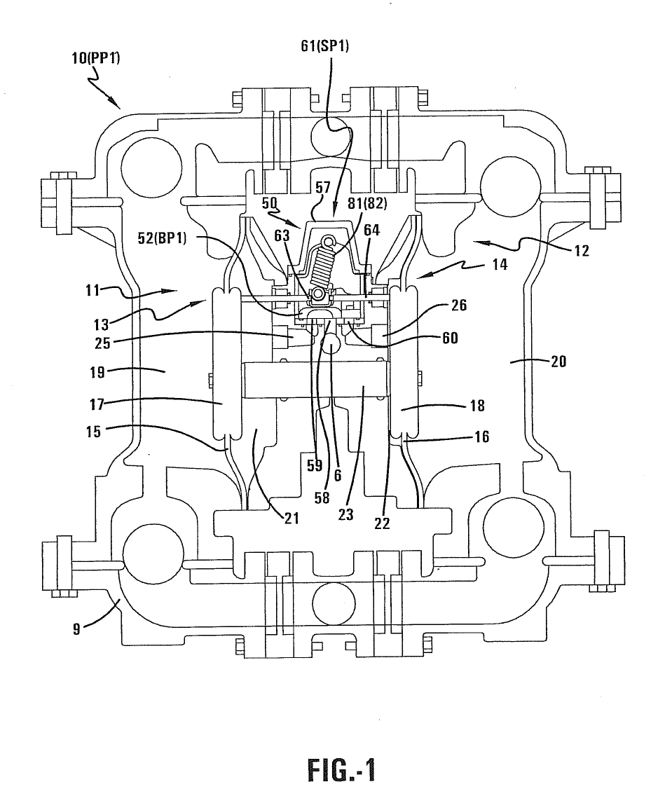

Referring now to the drawings wherein the showings are for purposes of illustrating embodiments of the invention only and not for purposes of limiting the same, FIG. 1 shows an air operated double diaphragm pump 10 comprising an air valve mechanism 50 according to one embodiment of the invention. The air valve mechanism 50 may comprise a single valve system that replaces the two valve system found in conventional air operated double diaphragm pumps. The position of the valve may be determined by the diaphragm motion of the pump up to a stall position. A spring-loaded mechanical actuation may complete the valve action from the stall position to the final or end of stroke position of the pump. While the air valve mechanism 50 may be advantageously used for various purposes, the air valve mechanism 50 will be described below in connection with an air actuated diaphragm pump apparatus having reciprocating diaphragms for pumping liquid such as, for example, solutions, viscous materials, slurries, or suspensions containing substantial amounts of solids. “Pumped fluid” used herein refers to and includes all such materials.

With reference now to FIGS. 1-3, the air operated double diaphragm pump 10 may generally be described as a pump having a first diaphragm 15 and a second diaphragm 16 connected together by a connecting rod 23. The first diaphragm 15 extends across a first diaphragm chamber 11 and defines on one side a first pumping chamber 19 and on the other side a first fluid chamber 21. The second diaphragm 16 extends across a second diaphragm chamber 12 and defines on one side a second pumping chamber 20 and on the other side a second fluid chamber 22. A fluid under pressure, commonly compressed air, is alternately introduced into and exhausted from the first and second fluid chambers 21, 22 under control of the air valve mechanism 50. The air valve mechanism 50 causes compressed air to be introduced into one of the fluid chambers, for example the first fluid chamber 21, to cause the first diaphragm 15 to move in a pumping stroke while the connecting rod 23 pulls the other diaphragm, in this example the second diaphragm 16, in a suction stroke thereby causing compressed air to be forced out of or exhausted from the second fluid chamber 22. The introduction of compressed air into the first fluid chamber 21 causes pumped fluid to be exhausted from the first pumping chamber 19. The exhaustion of compressed air from the second fluid chamber 22 causes pumped fluid to be drawn into the second pumping chamber 20. Upon compressed air being sufficiently introduced into the first fluid chamber 21, the air valve mechanism 50 causes the process to reverse wherein compressed air is introduced into the second fluid chamber 22 and exhausted from the first fluid chamber 21. The process is then repeated as desired to cause the pumping of the pumped fluid. Hereinafter, the terms “air,” “compressed air,” and “compressed fluid” may be used interchangeably to refer to a fluid under pressure.

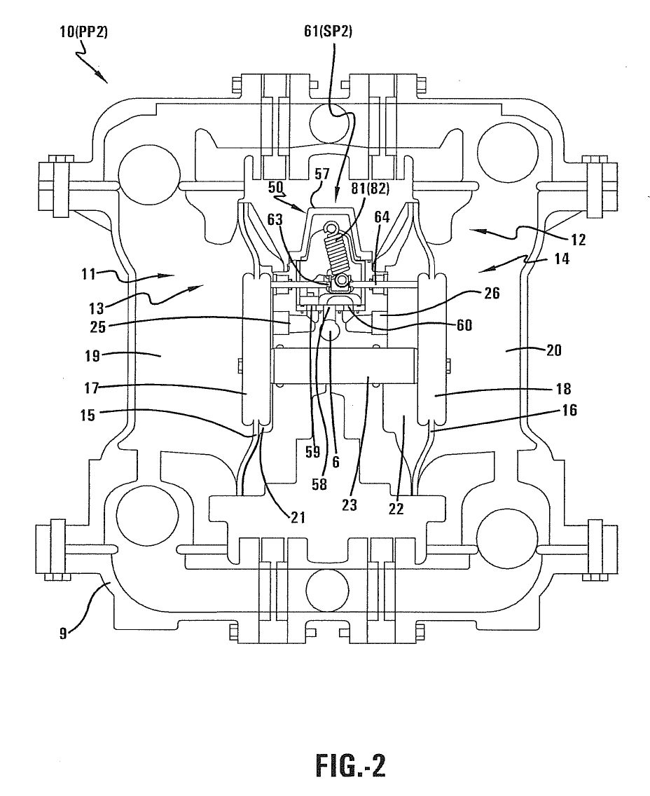

With reference now to FIGS. 1 and 2, the pump 10 may comprise the first diaphragm chamber 11 and the second diaphragm chamber 12. The first and second diaphragm chambers 11, 12 may comprise a first and second diaphragm assembly 13, 14 respectively. The first diaphragm assembly 13 may comprise the first diaphragm 15 and a first diaphragm plate 17. The first diaphragm 15 may be operatively coupled to the first diaphragm plate. The second diaphragm assembly 14 may comprise the second diaphragm 16 and a second diaphragm plate 18. The second diaphragm 16 may be operatively coupled to the second diaphragm plate. The first and second diaphragms 15, 16 may divide the first and second diaphragm chambers 11, 12 into the first and second pumping chambers 19, 20 and the first and second fluid chambers 21, 22, respectively, as described above. The connecting rod 23 may be connected to the first and second diaphragm plates 17, 18 so that the diaphragm assemblies 13, 14 may reciprocate together as described above between a first end of stroke or pump position PP 1 and a second end of stroke or pump position PP2. In the first pump position PP1, shown in FIG. 1, the first diaphragm assembly 13 may be positioned such that compressed air has been sufficiently introduced into the first fluid chamber 21, via a first chamber inlet 25, to cause pumped fluid to be sufficiently exhausted from the first pumping chamber 19. The second diaphragm assembly 14 may be positioned such that compressed air has been exhausted from the second fluid chamber 22, via a second chamber inlet 26, and pumped fluid has been drawn into the second pumping chamber 20.

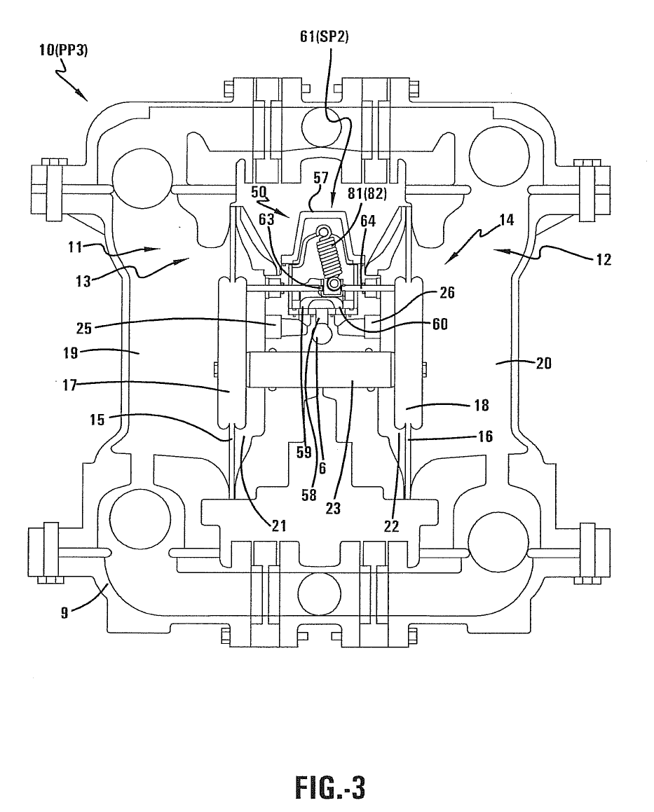

With reference now to FIGS. 1, 2, and 3, in the second pump position PP2, shown in FIG. 2, the second diaphragm assembly 14 may be positioned such that compressed air has been sufficiently introduced into the second fluid chamber 22, via the second chamber inlet 26, to cause pumped fluid to be sufficiently exhausted from the second pumping chamber 20. The first diaphragm assembly 13 may be positioned such that compressed air has been exhausted from the first fluid chamber 21, via the first chamber inlet 25, and pumped fluid has been drawn into the first pumping chamber 19. A third pump position, or stall position PP3 may be defined as substantially the midpoint between the first pump position PP1 and the second pump position PP2. The stall position PP3, shown in FIG. 3, may comprise a position wherein both the first and second fluid chambers 21, 22 are blocked off or compressed air is otherwise prevented from being introduced into or exhausted from the first and second fluid chambers 21, 22. The introduction of compressed air into the second fluid chamber 22 may cause the pump 10 to move from the first pump position PP1 to the second pump position PP2 by causing the second diaphragm assembly 14 to move in a pumping stroke thereby causing the first diaphragm assembly 13 to move in a suction stroke. The introduction of compressed air into the first fluid chamber 21 may cause the pump 10 to move from the second pump position PP2 to the first pump position PP1 by causing the first diaphragm assembly 13 to move in a pumping stroke thereby causing the second diaphragm assembly 14 to move in a suction stroke.

With reference now to FIGS. 1, 3, and 7, in one embodiment, the air valve mechanism 50 may comprise a shoe-style valve block 52, a valve plate 56, the housing 57, and a swing arm assembly 61. The valve plate 56 may comprise the base or bottom portion of the housing 57. The valve plate 56 may include a plurality of passages or apertures that extend through the valve plate 56. The plurality of apertures may be suitable for communicating compressed air through the valve plate 56 as more fully described below. In one embodiment, the valve plate 54 may comprise an exhaust passage 58, a first air inlet passage 59, and a second air inlet passage 60. The exhaust passage 58 may be in fluid communication with an exhaust port 6 that allows compressed air to be exhausted from the pump 10. The first air inlet passage 59 may be in fluid communication with the first chamber inlet 25 and the second air inlet passage 60 may be in fluid communication with the second chamber inlet 26. The valve block 52 may be positioned to slide across the valve plate 56 within the housing 57. The valve block 52 may comprise an air conduit 55 formed in the lower portion of the valve block 52 adjacent to the valve plate 56. The air conduit 55 may allow for the selective coupling of the plurality of apertures formed in the valve plate 56 wherein the air conduit 55 causes the coupled apertures to be in fluid communication with each other.

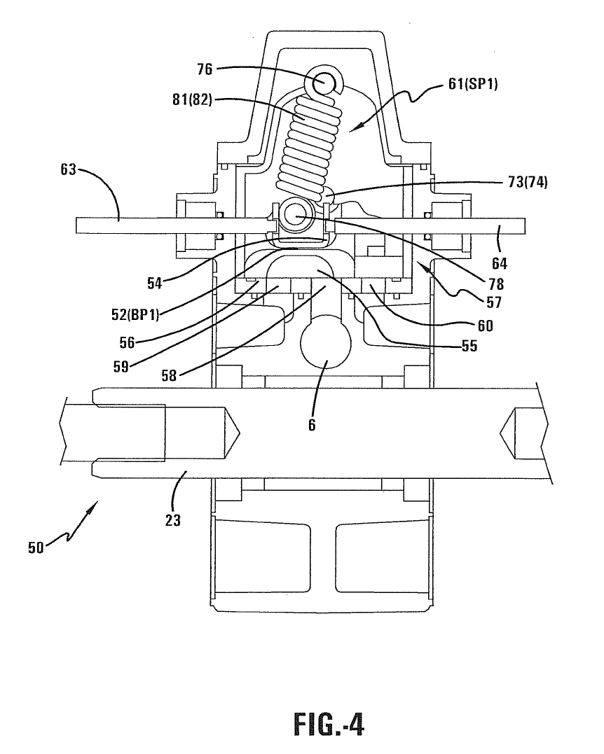

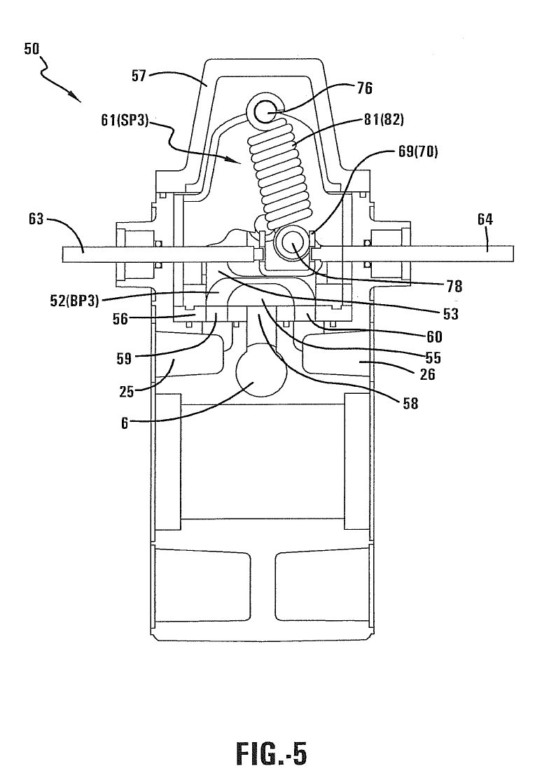

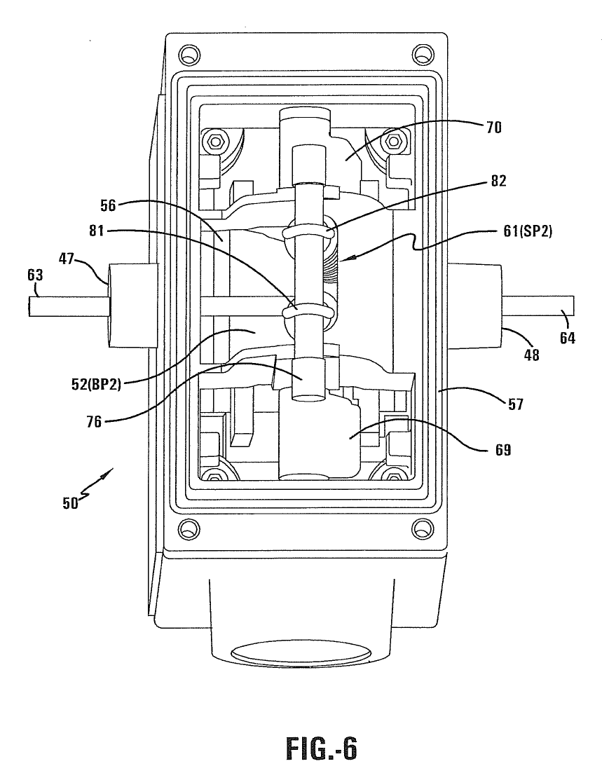

With reference now to FIGS. 1-6, in one embodiment, the valve block 52 may move or slide back and forth over the valve plate 56 between a first block position BP1 and a second block position BP2. In the first block position BP1, the air conduit 55 may be positioned to cause the first air inlet passage 59 to be in fluid communication or coupled with the exhaust passage 58 while allowing compressed air to be introduced into the second air inlet passage 60. The compressed air may be supplied from any suitable source such as a conduit, not shown, that is in fluid communication with a pump inlet, not shown. The pump inlet, not shown, may be in fluid communication with a compressed air supply, not shown, that supplies compressed air for operating the pump 10. In one embodiment, the valve block 52 may slide far enough across the valve plate 56 to substantially uncover or be out of contact with the second air inlet passage 60. Therefore, the movement of the valve block 52 into the first block position BP1 may cause the second diaphragm assembly 14 to begin a pumping stroke and the first diaphragm assembly 13 to begin a suction stroke as the pump 10 begins moving towards the second pump position PP2. Stated differently, the movement of the valve block 52 into the first block position BP1 may cause compressed air to be introduced into the second fluid chamber 22 and exhausted from the first fluid chamber 21. In the second block position BP2, the air conduit 55 may be positioned to cause the second air inlet passage 60 to be in fluid communication or connected with the exhaust passage 58 while allowing compressed air to be introduced into the first inlet passage 59. In one embodiment, the valve block 52 may slide far enough across the valve plate 56 to substantially uncover or be out of contact with the first air inlet passage 59. Therefore, the movement of the valve block 52 into the second block position BP2 may cause the first diaphragm assembly 13 to begin a pumping stroke and the second diaphragm assembly 14 to begin a suction stroke as the pump 10 begins moving towards the first pump position PP1. Stated differently, the movement of the valve block 52 into the second block position BP2 may cause compressed air to be introduced into the first fluid chamber 21 and exhausted from the second fluid chamber 22. In the stall position PP3, the valve block 52 may be positioned in a third block position BP3. The third block position BP3 may coincide with the stall position PP3 of the pump 10 and may prevent the first inlet air passage 59 or the second inlet air passage 60 to be in fluid communication with or coupled to either the exhaust passage 58 or the compressed air supply, not shown. In one embodiment, in the third block position BP3 the valve block 52 may be positioned to substantially cover or block the first and second inlet air passages 59, 60.

With reference now to FIGS. 2 and 4-7, the swing arm assembly 61 may be rotatably connected to the housing 57 and may at least partially cause the valve block 52 to move between the first and second block positions BP1, BP2. The swing arm assembly 61 may comprise a first swing arm 69 and a second swing arm 70 that are rotatably coupled to the housing 57. In one embodiment, the first and second swing arms 69, 70 may rotate about a first and second swing arm support pin 73, 74, respectively. The first and second swing arm support pins 73, 74 may be positioned substantially outside the width of the valve block 52 and substantially along a vertical center line VC. A lower spring pin 78 may be coupled to and extend between the first and second swing arms 69, 70 substantially along the vertical centerline VC. At least a portion of the lower spring pin 78 may be positioned within a swing arm recess 51. The swing arm recess 51 may be formed in the upper portion of the valve block 52 and may be at least partially defined by a first block face 53 and a second block face 54. The first and second swing arms 69, 70 may allow the lower spring pin 78 to swing or rotate in an arc motion between a first swing arm position SP1 and a second swing arm position SP2. The arc motion, swinging, or rotating of the lower spring pin 78 between the first swing arm position SP1 and the second swing arm position SP2 may cause at least a portion of the swing arm assembly 51 to urge the valve block 52 into the first block position BP1 or the second block position BP2. The first swing arm position SP1 may substantially coincide with the first pump position PP1 and the second swing arm position SP2 may substantially coincide with the second pump position PP2. In the stall position PP3, the lower spring pin 78 may comprise a third swing arm position SP3. The third swing arm position SP3 may be located substantially at the midpoint between the first and second swing arm positions SP1, SP2. In one embodiment, the movement of the lower spring pin 78 towards the first swing arm position SP1 may cause the lower spring pin 78 to contact the first block face 53 of the swing arm recess 51 thereby urging the valve block 52 towards the first block position BP1. The movement of the lower spring pin 78 towards the second swing arm position SP2 may cause the lower spring pin 78 to contact the second block face 54 of the swing arm recess 51 thereby urging the valve block 52 towards the second block position BP2.

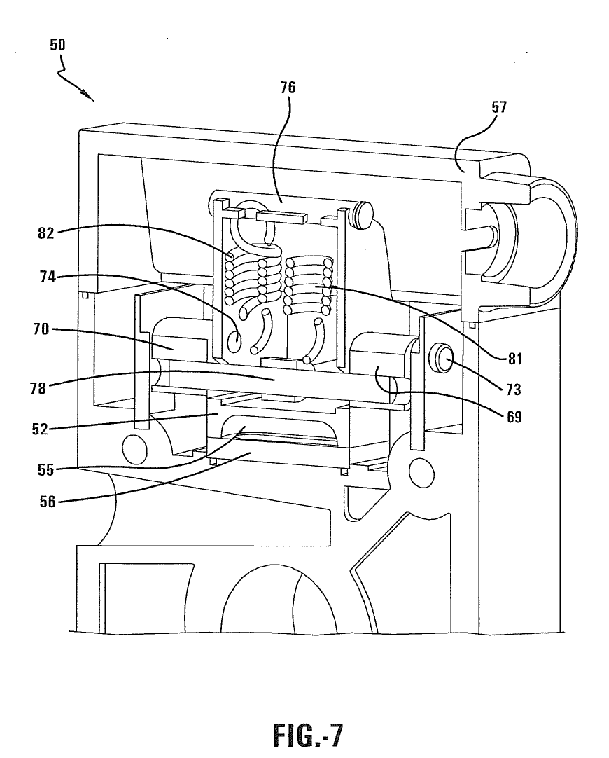

With continued reference now to FIGS. 2 and 4-7, at least a first spring 81 may extend from the lower spring pin 78 to an upper spring pin 76. The first spring 81 may provide a mechanical means for urging the lower spring pin 78 away from the third swing arm position SP3 and towards the first or second swing arm position SP1, SP2 thereby urging the pump 10 away from the stall position PP3 and towards the first or second pump positions PP1, PP2. In one embodiment, the spring 81 may comprise a helical or compression spring 81. Although a specific spring is shown, the first spring 81 may comprise any type of spring or any means for urging the lower swing pin 78 away from the third swing arm position SP3 and towards the first or second swing arm position SP1, SP2, chosen with sound judgment by a person of ordinary skill in the art. In one embodiment, the swing arm assembly 61 may comprise the first spring 81 and a second spring 82 that extend between the upper and lower spring pins 76, 78. The upper spring pin 76 may be rotatably coupled to the housing 57. The upper spring pin 76 may be positioned substantially between the first and second swing arms 69, 70, above the valve block 52, and along the vertical centerline VC but, spaced radially apart from the first and second swing arm support pins 73, 74, as more clearly shown in FIG. 7. The arc motion of the lower spring pin 78 between the first and second swing arm positions SP1, SP2 may cause the extension and retraction of the first and second springs 81, 82. The first and second springs 81, 82 may attain a maximum amount of extension, thereby exerting a maximum amount of force on the lower spring pin 78, when the lower spring pin 78 is in the third swing arm position SP3. The first and second springs 81, 82 may be substantially fully retracted, thereby exerting substantially no or a minimal amount of force on the lower spring pin 78, when the lower spring pin 78 is in the first or second swing arm position SP1, SP2.

With reference now to FIGS. 1-5, the movement of the diaphragm assemblies 13, 14 between the first and second pump positions PP1, PP2 may at least partially cause the valve block 52 to move between the first and second block positions BP1, BP2. In one embodiment, a first and second push rod 63, 64 may extend between and be operatively coupled to the swing arm assembly 61 and the first and second diaphragm assemblies 13, 14, respectively. The movement of the pump 10 towards the second pump position PP2 may cause the first diaphragm assembly 13 to contact the first push rod 63. In one embodiment, the first diaphragm plate 17 may contact the first push rod 63 thereby causing the first push rod 63 to cause the lower spring pin 78 to move away from the first swing arm position SP1 and towards the second swing arm position SP2. In one embodiment, the first push rod 63 may be coupled to lower spring pin 78 and may cause the lower spring pin 78 to move away from the first swing arm position SP1 by contacting a portion of the swing arm assembly 61. In another embodiment, the first push rod 63 may be coupled to the first and/or second swing arm 69, 70. The movement of the lower spring pin 78 may cause the valve block 52 to move from the first block position BP1 towards the second block position BP2. In one embodiment, the lower spring pin 78 may contact the second block face 54. In another embodiment, a portion of the first and/or second swing arm 69, 70 may contact the second block face 54. The movement of the lower spring pin 78 away from the first swing arm position SP1 may cause the first and second springs 81, 82 to be extended. As the pump 10 reaches the stall position PP3, the lower spring pin 78 may be positioned such that the swing arm assembly 61 is substantially positioned in the third swing arm position SP3 thereby causing the first and second springs 81, 82 to be at a maximum extension. Upon passing the stall position PP3, the first and second springs 81, 82 may begin to compress or retract thereby urging the lower spring pin 78 towards the second swing arm position SP2 thereby causing the valve block 52 to move away from the third block position BP3.

With continued reference now to FIGS. 1-5, the movement of the pump 10 towards the first pump position PP1 may cause the second diaphragm assembly 14 to contact the second push rod 64. In one embodiment, the second diaphragm plate 18 may contact the second push rod 64 thereby causing the second push rod 64 to cause the lower spring pin 78 to move away from the second swing arm position SP2 and towards the first swing arm position SP1. In one embodiment, the second push rod 64 may be coupled to lower spring pin 78. In another embodiment, the second push rod 64 may be coupled to the first and/or second swing arm 69, 70. The movement of the lower spring pin 78 may cause the valve block 52 to move from the second block position BP2 towards the first block position BP1. In one embodiment, the lower spring pin 78 may contact the first block face 53. In another embodiment, a portion of the first and/or second swing arm 69, 70 may contact the first block face 53. The movement of the lower spring pin 78 away from the second swing arm position SP2 may cause the first and second springs 81, 82 to be extended. As the pump 10 reaches the stall position PP3, the lower spring pin 78 may be positioned such that the swing arm assembly 61 is substantially positioned in the third swing arm position SP3 thereby causing the first and second springs 81, 82 to be at a maximum extension. Upon passing the stall position PP3, the first and second springs 81, 82 may begin to compress or retract thereby urging the lower spring pin 78 towards the first swing arm position SP1 thereby causing the valve block 52 to move away from the third block position BP3. Upon the pump 10 reaching the first pump position PP1, the process may be repeated.

With reference now to FIGS. 1, 2, 6, and 7, the air valve mechanism 50 may be operatively coupled between the first and second diaphragm assemblies 13, 14 to enable the drawing and exhausting of compressed air as the first and second diaphragm assemblies 13, 14 reciprocate between the first and second pump positions PP 1, PP2 as described above. In one embodiment, the air valve mechanism 50 may be at least partially contained within a housing 57, as shown in FIG. 7, that is removably connected to the pump 10. In this embodiment, at least a portion of the air valve mechanism 50, for example, the swing arm assembly 61, may be a selectively removable module that allows for the in-line servicing of the air valve mechanism 50. The air valve mechanism 50 may comprise a preassembled module that can be retrofitted to an existing pump. The housing 57 may allow at least a portion of the air valve mechanism 50 to be selectively removed from the pump 10 thereby allowing for the in-line servicing of the air valve mechanism 50. For example, the pump 10 may operate for a first period of time. Upon expiration of the first period of time, the housing 57 may be detached or removed from the pump housing 9, thereby removing at least a portion of the air valve mechanism 50, for example, the swing arm assembly 61, to perform in-line servicing of at least a portion of the air valve mechanism 50. The in-line servicing of the air valve mechanism 50 may include performing maintenance, repairing, or replacing at least a component of the air valve mechanism 50 or, substantially completely replacing the first air valve mechanism 50 with a second air valve mechanism. Stated differently, the housing 57 may at least partially allow at least a portion of the air valve mechanism 50 to be selectively coupled to and removed from the pump 10 without requiring a significant amount of disassembly of the pump 10. In one embodiment, the swing arm assembly 61, at least partially contained within the housing 57, may be selectively attached to the pump housing 9 via conventional fasteners, such as, for example, four bolts, not shown.

With continued reference to FIGS. 1, 2, 6, and 7, in one embodiment the housing 57 may comprise a first and second housing aperture 47, 48. The first and second housing apertures 47, 48 may receive the first and second push rods 63, 64. The first and second push rods may be fixedly coupled to the first and second diaphragm assemblies 13, 14, respectively, and may extend through the first and second housing apertures 47, 48 to contact at least a portion of the air valve mechanism 50 to at least partially cause the movement of the valve block 52 as described above. The first and second push rods may remain coupled to the first and second diaphragm assemblies 13, 14 when the air valve mechanism 50 is selectively removed from the pump 10. Optionally, the valve plate 56 may be fixedly connected to the pump 10 to remain coupled to the pump 10 when the swing arm assembly 61 is selectively removed. In one embodiment, the housing 57 may receive at least a portion of the valve plate 56 when the swing arm assembly 61 is removably connected to the pump 10. In another embodiment, the valve block 52 may define a surface of the housing 57 thereby allowing the valve plate 56 to substantially abut the housing 57 when the swing arm assembly 61 is removably connected to the pump 10.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A pump comprising:
a first diaphragm chamber comprising a first diaphragm assembly, wherein the first diaphragm assembly defines a first pumping chamber and a first fluid chamber within the first diaphragm chamber;
a second diaphragm chamber comprising a second diaphragm assembly, wherein the second diaphragm assembly defines a second pumping chamber and a second fluid chamber within the second diaphragm chamber;
a connecting rod connected between the first diaphragm assembly and the second diaphragm assembly to at least partially cause the first diaphragm assembly and the second diaphragm assembly to reciprocate between a first pump position and a second pump position; and,
an air valve mechanism comprising:
a valve plate comprising at least a first aperture suitable for allowing the passage of compressed air through the valve plate;
a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position;
a swing arm assembly, wherein the swing arm assembly urges the valve block away from a stall position and towards the first block position or the second block position.

2. The pump of claim 1, further comprising:
a housing, wherein the air valve mechanism is positioned substantially within the housing and the housing allows at least a portion of the air valve mechanism to be selectively removed from the pump.

3. The pump of claim 2, wherein the valve plate remains fixedly connected to the pump when the housing is selectively removed from the pump.

4. The pump of claim 1, wherein the swing arm assembly further comprises:
an upper spring pin;
a lower spring pin;
a first swing arm;
a second swing arm; and,
at least a first spring that extends between the upper spring pin and the lower spring pin and has substantially a minimum amount of deflection at the first and second block positions and a maximum amount of deflection at the stall position,
wherein the lower spring pin is coupled to and extends between the first and second swing arms, the lower spring pin is urged away from the stall position by the first spring, and the lower spring pin at least partially causes the completion of the movement of the valve block to the first or second block position.

5. The pump of claim 4, wherein the lower spring pin at least partially causes the completion of the movement of the valve block to the first or second block position by contacting a block face of the valve block, the block face at least partially defining a swing arm recess formed in the valve block, and at least a portion of the lower spring pin, the first swing arm, or the second swing arm is positioned within the swing arm recess.

6. The pump of claim 4, wherein the first swing arm rotates about a first swing arm support pin and the second swing arm rotates about a second swing arm support pin, the first and second swing arm support pins are positioned substantially outside the width of the valve block and along a vertical centerline, the lower spring pin extends across the width of the valve block and is positioned substantially between but radially apart from the first and second swing arm support pins.

7. An air valve mechanism comprising:
a housing;
a valve block;
a valve plate; and,
a swing arm assembly,
wherein the housing allows at least a portion of the air valve mechanism to be removably connected to an associated pump,
wherein the valve block, the valve plate, and the swing arm assembly are positioned substantially within the housing,
wherein the valve plate comprises a first aperture, a second aperture, and a third aperture suitable for allowing the passage of a compressed fluid through the valve plate,
wherein the valve block is positioned to move between a first block position that causes the first aperture to be in fluid communication with the second aperture and a second block position that causes the second aperture to be in fluid communication with the third aperture,
wherein the movement of the valve block between the first block position and the second block position is at least partially caused by the movement of a first diaphragm assembly and a second diaphragm assembly of the associated pump,
wherein the swing arm assembly provides a mechanical actuation that at least partially causes the valve block to move from a third block position that coincides with a stall position of the associated pump to the first or second block position.

8. The air valve mechanism of claim 7, wherein the swing arm assembly comprises:
an upper spring pin that extends over the width of the valve block along a vertical centerline;
a lower spring pin that extends over the width of the valve block along the vertical centerline and is spaced radially apart from the upper spring pin;
a first swing arm support pin and a second swing arm support pin positioned substantially outside the width of the valve block along the vertical centerline between the upper and lower support pins;
a first swing arm and a second swing arm, wherein the first swing arm rotates about the first swing arm support pin and the second swing arm rotates about the second swing arm support pin and the lower spring pin extends between and is coupled to the first and second swing arms.

9. The air valve mechanism of claim 7, wherein the valve block further comprises:
a swing arm recess, wherein the swing arm recess is at least partially defined by a first block face and a second block face and a lower spring pin that extends across the width of the valve block at least partially within the swing arm recess and contacts the first block face or the second block face to move the valve block from the third block position.

10. A method comprising the steps of:
(a) providing a pump comprising:
a first diaphragm chamber comprising a first diaphragm assembly, wherein the first diaphragm assembly defines a first pumping chamber and a first fluid chamber within the first diaphragm chamber;
a second diaphragm chamber comprising a second diaphragm assembly, wherein the second diaphragm assembly defines a second pumping chamber and a second fluid chamber within the second diaphragm chamber;
a connecting rod connected between the first diaphragm assembly and the second diaphragm assembly to at least partially cause the first diaphragm assembly and the second diaphragm assembly to reciprocate between a first pump position and a second pump position; and,
an air valve mechanism comprising:
a valve plate comprising at least a first aperture suitable for allowing the passage of compressed air through the valve plate;
a valve block, wherein the valve block moves over at least a portion of the valve plate between a first block position and a second block position to cause a compressed fluid to be introduced into the first fluid chamber or the second fluid chamber and the movement of the first diaphragm assembly and the second diaphragm assembly between the first pump position and the second pump position at least partially causes the valve block to move between the first block position and the second block position;
a swing arm assembly, wherein the swing arm assembly urges the valve block away from a stall position and towards the first block position or the second block position; and,
a housing, wherein at least a portion of the air valve mechanism is positioned within the housing and the housing is removably connected to the pump;
(b) operating the pump for a first period of time;
(c) removing the housing and the at least a portion of the air valve mechanism that is positioned within the housing to provide in-line service to the air valve mechanism;
(d) connecting the housing to the pump; and,
(e) operating the pump for a second period of time.

11. The method of claim 10, wherein the step (a) further comprises the step of:
attaching the housing to the exterior portion of a pump housing.

12. The method of claim 10, wherein step (c) further comprises the step of:
leaving the valve plate coupled to the pump.

13. The method of claim 10, wherein step (c) further comprises the step of:
withdrawing a first and a second push rod from a first and a second housing aperture respectively, wherein the first and second push rods are operatively connected to the first and second diaphragm assemblies and contact at least a portion of the swing arm assembly to at least partially cause the valve block to move between the first and second block positions; and,
step (d) further comprises the step of:
inserting the first and second push rods into the first and second housing apertures respectively.

14. The method of claim 10, wherein step (b) further comprises the steps of:
contacting at least a portion of the swing arm assembly with a first push rod to at least partially cause the valve block to move from the first block position;
deforming at least a first spring as the valve block moves from the first block position to the stall position;
relaxing the at least a first spring as the valve block moves from the stall position to the second block position, wherein the relaxing of the at least a first spring urges the valve block away from the stall position and towards the second block position.

15. The method of claim 10, wherein step (b) further comprises the steps of:
contacting at least a portion of the swing arm assembly with a first push rod to at least partially cause the valve block to move from the first block position;
deforming at least a first spring as the valve block moves from the first block position to the stall position;
relaxing the at least a first spring as the valve block moves from the stall position to the second block position, wherein the relaxing of the at least a first spring urges the valve block away from the stall position and towards the second block position;
contacting at least a portion of the swing arm assembly with a second push rod to at least partially cause the valve block to move from the second block position;
deforming the at least a first spring as the valve block moves from the second block position to the stall position;
relaxing the at least a first spring as the valve block moves from the stall position to the first block position, wherein the relaxing of the at least a first spring urges the valve block away from the stall position and towards the first block position.
